(19) United States
(12) Patent Application Publication
(10) Pub. No.: US 2025/0247652 A1
(43) Pub. Date: Jul. 31, 2025

(54) GLASS DIAPHRAGM AND EXCITER-ATTACHED GLASS DIAPHRAGM

(71) Applicant: AGC Inc., Tokyo (JP)

(72) Inventors: Kento SAKURAI, Tokyo (JP); Jun Akiyama, Tokyo (JP)

(73) Assignee: AGC Inc., Tokyo (JP)

(21) Appl. No.: 19/180,704

(22) Filed: Apr. 16, 2025

Related U.S. Application Data
(63) Continuation of application No. PCT/JP2023/033387, filed on Sep. 13, 2023.

(30) Foreign Application Priority Data
Oct. 19, 2022 (JP) 2022-167895

(51) Int. Cl. H04R 7/10; H04R 7/16; H04R 9/02

(52) U.S. Cl. CPC H04R 7/10; H04R 7/16; H04R 9/025; H04R 2307/023; H04R 2307/025

(57) ABSTRACT

A glass diaphragm includes a glass plate structure; a mount portion fixed to a principal surface of the glass plate structure on one side; a connection portion provided on a side of the mount portion that is opposite to the glass plate structure and to which an exciter for vibrating the glass plate structure is mechanically attached; and an elastic deformation layer provided on a principal surface of the mount portion on a side opposite to the glass plate structure.

### CROSS-REFERENCE TO RELATED APPLICATIONS

This application is a continuation application of International Application No. PCT/JP2023/033387 filed Sep. 13, 2023 the disclosure of which is incorporated herein by reference in its entirety. Further, this application claims priorities from Japanese Patent Application No. 2022-167895 filed Oct. 19, 2022, the disclosure of which is incorporated herein by reference in their entirety.

### TECHNICAL FIELD

The present disclosure relates to a glass diaphragm and an exciter-attached glass diaphragm.

### RELATED ART

In recent years, a technology of vibrating a glass plate to cause the glass plate to function as a speaker has been studied. WO 2021/229179 A discloses a structure in which a sole and a base are fixed on a glass plate by molding, and an exciter (vibrator) is attached to the base via a connection portion. WO 2021/229180 A discloses a structure in which a through hole is formed in a glass plate, a lower portion of a base is inserted into the through hole, and an exciter is attached to an upper portion of the base.

However, in the structures disclosed in WO 2021/229179 A and WO 2021/229180 A, in a case where a fixed state of the exciter (vibrator) varies, there is a possibility that an individual difference occurs in a damping ratio when a glass plate structure is vibrated.

### SUMMARY

An object of the present disclosure is to obtain a glass diaphragm and an exciter-attached glass diaphragm capable of reducing an individual difference and reproducing a desired acoustic characteristic.

A glass diaphragm according to the present disclosure includes: a glass plate structure; a mount portion fixed to a principal surface of the glass plate structure on one side; a connection portion provided on a side of the mount portion that is opposite to the glass plate structure and to which an exciter for vibrating the glass plate structure is mechanically attached; and an elastic deformation layer provided on a principal surface of the mount portion on a side opposite to the glass plate structure.

With the glass diaphragm and the exciter-attached glass diaphragm according to the present disclosure, it is possible to reduce an individual difference and reproduce a desired acoustic characteristic.

### BRIEF DESCRIPTION OF DRAWINGS

FIG. 1 is a cross-sectional view of an exciter-attached glass diaphragm according to an embodiment when viewed from a side.

FIG. 2 is a cross-sectional view of an exciter-attached glass diaphragm according to a first modified example when viewed from a side.

FIG. 3 is a cross-sectional view of an exciter-attached glass diaphragm according to a second modified example when viewed from a side.

FIG. 4 is a cross-sectional view of an exciter-attached glass diaphragm according to a third modified example when viewed from a side.

FIG. 5 is an enlarged cross-sectional view showing a mount portion and an elastic deformation layer according to a fourth modified example.

FIG. 6 is an enlarged cross-sectional view showing a mount portion and an elastic deformation layer according to a fifth modified example.

FIG. 7 is an enlarged cross-sectional view showing a mount portion and an elastic deformation layer according to a sixth modified example.

FIG. 8 is an enlarged cross-sectional view showing a mount portion and an elastic deformation layer according to a seventh modified example.

FIG. 9 is a perspective view of a mount portion according to an eighth modified example.

FIG. 10 is a perspective view of a mount portion according to a ninth modified example.

FIG. 11 is a perspective view of a mount portion according to a tenth modified example.

FIG. 12 is a perspective view of a mount portion according to an eleventh modified example.

FIG. 13 is a perspective view of a mount portion according to a twelfth modified example.

FIG. 14 is a perspective view of a mount portion according to a thirteenth modified example.

FIG. 15 is a cross-sectional view of an exciter-attached glass diaphragm according to a fourteenth modified example when viewed from a side.

FIG. 16 is a cross-sectional view of an exciter-attached glass diaphragm according to a fifteenth modified example when viewed from a side.

FIG. 17 is a cross-sectional view of an exciter-attached glass diaphragm according to a sixteenth modified example when viewed from a side.

FIG. 18 is a cross-sectional view of an exciter-attached glass diaphragm according to a seventeenth modified example when viewed from a side.

### DETAILED DESCRIPTION

An exciter-attached glass diaphragm 10 according to an embodiment will be described with reference to the drawings.

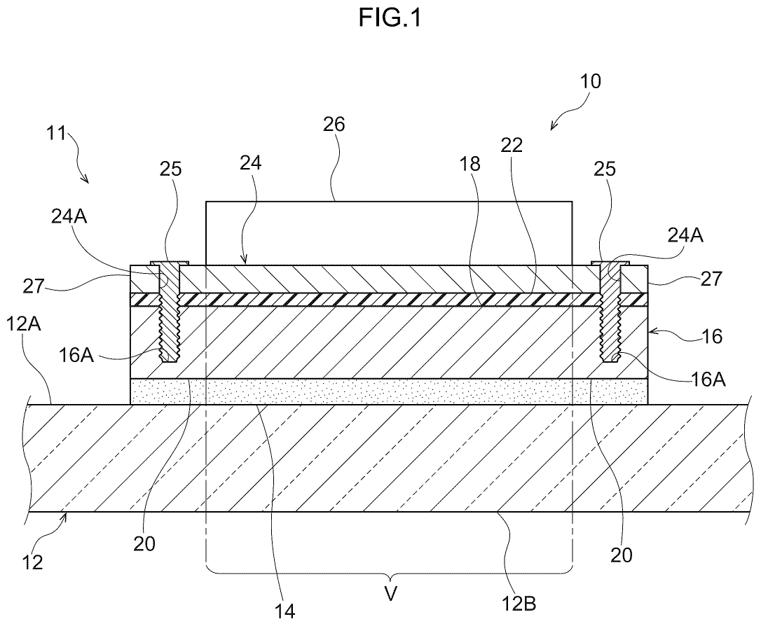

FIG. 1 is a cross-sectional view of the exciter-attached glass diaphragm 10 when viewed from a side. As shown in FIG. 1, the exciter-attached glass diaphragm 10 according to the present embodiment includes a glass diaphragm 11 and an exciter 26.

The glass diaphragm 11 according to the present embodiment includes a glass plate structure 12, a mount portion 16, and a connection portion 24.

### (Glass Plate Structure 12)

The glass plate structure 12 may be formed of a single glass plate (single plate glass) or may be formed of laminated glass from the viewpoint of improving an acoustic effect as the glass diaphragm 11. For example, the glass plate structure 12 may be formed of laminated glass in which a first glass plate, an intermediate layer, and a second glass plate are layered. The glass plate structure 12 may be a window glass attached to a vehicle. For example, the glass plate structure 12 is used for a windshield, a side glass, a rear glass, a reactor glass, a front bench glass, a roof glass, a window reflector, and the like, and can also be used for applications such as window glass of a building other than a vehicle.

The glass plate structure 12 may be formed of transparent or translucent inorganic glass or may be formed of organic glass. Examples of the inorganic glass include soda-lime glass, aluminosilicate glass, borosilicate glass, alkali-free glass, and quartz glass. Examples of the organic glass include a polymethyl methacrylate (PMMA)-based resin, a polycarbonate (PC)-based resin, a polystyrene (PS)-based resin, a polyethylene terephthalate (PET)-based resin, a polyvinyl chloride (PVC)-based resin, and a cellulose-based resin. Furthermore, in a case where the glass plate structure 12 is formed of the laminated glass, a glass plate adjacent to the mount portion 16 may be formed as a plate-like body formed of a material other than glass. For example, a resin plate formed of a transparent resin material such as an acrylic plate may be used, or a fiber-reinforced plastic containing glass fibers or carbon fibers may be used.

A thickness of the glass plate structure 12 is preferably 1.0 [mm] or more, more preferably 2.0 [mm] or more, and still more preferably 3.0 [mm] or more. Thus, the glass plate structure 12 can have a necessary and sufficient strength. In a case where the glass plate structure 12 is formed of the laminated glass, a thickness of each glass plate is preferably 5.0 [mm] or less, more preferably 3.0 [mm] or less, and still more preferably 2.0 [mm] or less. Furthermore, the thickness of each glass plate is preferably 0.1 [mm] or more, more preferably 0.5 [mm] or more, and still more preferably 1.0 [mm] or more.

The intermediate layer of the laminated glass is formed of a transparent polyvinyl butyral (PVB)-based or ethylene-vinyl acetate copolymer (EVA)-based resin film, or a resin film containing a thermoplastic and thermosetting adhesive material such as a silicone (PDMS)-based resin film, a polyurethane-based resin film, a fluorine-based resin film, a polyethylene terephthalate-based resin film, or a polycarbonate-based resin film. Further, the intermediate layer is not limited to the resin film, and may be formed of a fluid layer containing a liquid or a gel-like body, and in this case, a high loss factor can be achieved. The “fluid” includes all those having fluidity including a liquid, such as a liquid, a semi-solid, a mixture of solid powder and a liquid, and a solid gel (jelly-like substance) impregnated with a liquid. Furthermore, a material that enhances a sound insulation property, a material that absorbs ultraviolet rays and infrared rays, and the like may be added to the intermediate layer, or a multilayer intermediate layer including a functional layer may be used. A thickness of the intermediate layer may be set to, for example, 1.0 [nm] or more and 1.0 [mm] or less, 0.1 [μm] or more and 0.9 [mm] or less, or 0.2 [μm] or more and 0.8 [mm] or less.

In a case where the glass plate structure 12 is formed of the laminated glass, the laminated glass is not limited to laminated glass in which one intermediate layer is sandwiched between two glass plates. For example, two or more intermediate layers may be sandwiched between two glass plates, and a light control film that electrically varies a visible light transmittance may be sandwiched between two or more intermediate layers. Furthermore, the glass plate structure 12 may have a configuration in which each intermediate layer is sandwiched between adjacent glass plates among three or more glass plates.

### (Mount Portion 16)

The glass plate structure 12 has a principal surface 12A on one side and a principal surface 12B on the other side, and the mount portion 16 is fixed to the principal surface 12A on one side via an adhesive layer 14. An adhesive, a pressure-sensitive adhesive, and the like can be appropriately used as the adhesive layer 14. A pressure-sensitive adhesive tape formed in a sheet shape can be used as the pressure-sensitive adhesive. A sheet-shaped thermosetting resin material or the like may be used as the adhesive layer 14.

It is sufficient if a thickness of the adhesive layer 14 is 5.0 [mm] or less, because the thinner the adhesive layer 14 is, the more effective the vibration from the exciter 26 can be transmitted to the glass plate structure 12, and the thickness of the adhesive layer 14 is preferably 3.0 [mm] or less, more preferably 1.0 [mm] or less, and still more preferably 0.5 [mm] or less. Although the adhesive layer 14 according to the present embodiment is formed to have a uniform thickness, the thickness is not limited to a uniform thickness and may vary. The thickness of the adhesive layer 14 is preferably 0.001 [mm] or more, more preferably 0.005 [mm] or more, and still more preferably 0.01 [mm] or more from the viewpoint of maintaining a yield in a process of applying or bonding the adhesive, the pressure-sensitive adhesive, or the like.

The mount portion 16 is fixed to the adhesive layer 14. The mount portion 16 preferably has the same outer shape as the adhesive layer 14 when viewed from a plate thickness direction of the glass plate structure 12. The mount portion 16 includes a main mount portion 18 disposed in a connection region V overlapping the exciter 26 when viewed from the thickness direction of the glass plate structure 12, and first extending portions 20 extending outward from the main mount portion 18 (connection region V).

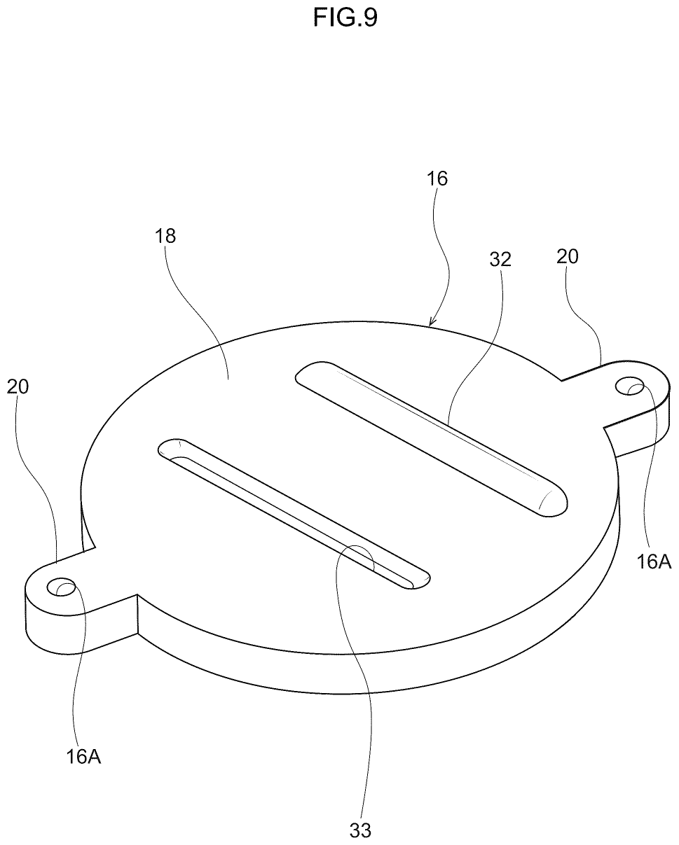

The first extending portions 20 extend from outer peripheral end portions of the main mount portion 18 in directions different from each other, particularly, in directions opposite to each other. Therefore, the outer shape of the mount portion 16 is similar to that in modified examples shown in FIGS. 9 to 12. The first extending portion 20 may be formed in a substantially annular shape or a substantial C-shape when viewed from the plate thickness direction of the glass plate structure 12. In addition, three or more first extending portions 20 may be arranged at equal intervals along the periphery of the main mount portion 18. For example, in a case where three first extending portions 20 having the same shape are provided, the first extending portions 20 may be arranged at intervals of 120° with respect to the center of the main mount portion 18 along an outer peripheral edge of the main mount portion 18.

A first hole 16A is formed in each of the first extending portions 20. The first hole 16A is opened on a side of the first extending portion 20 that is opposite to the glass plate structure 12, and can be exemplified by a screw hole into which a bolt 25 is screwed.

The mount portion 16 may be formed of metal including stainless steel, aluminum or an aluminum alloy, titanium or a titanium alloy, or the like, a stone material, wood, or the like, and a part of the mount portion 16 may be formed of a resin such as a plastic. As the plastic, a general engineering plastic such as an ABS-based plastic, a PVC-based plastic, a PC-based plastic, a PP-based plastic, a PBT-based plastic, a PA66-based plastic, or a PPS-based plastic may be used, and a fiber-reinforced plastic containing glass fibers or carbon fibers may be used. It is sufficient if a Young's modulus E_{M} of the mount portion 16 is 1×10⁷ [Pa] or more, and the Young's modulus E_{M} of the mount portion 16 is preferably 5×10⁷ [Pa] or more, and more preferably 1×10⁸ [Pa] or more. The Young's modulus E_{M} of the mount portion 16 is preferably 1×10¹² [Pa] or less from the viewpoint of ease of processing.

The main mount portion 18 and the first extending portion 20 may be made of the same material or different materials. For example, in a case where the first extending portion 20 is formed of a resin, rubber, or the like, even when the glass plate structure 12 has a curved shape, it is easy for the first extending portion 20 to follow the curved shape, and it is easy to effectively transmit the vibration from the exciter 26.

A thickness of the mount portion 16 is preferably 50 [mm] or less, more preferably 30 [mm] or less, still more preferably 20 [mm] or less, and particularly preferably 10 [mm] or less from the viewpoint of achieving height reduction with a smaller thickness of the mount portion 16. The main mount portion 18 and the first extending portion 20 may be formed to have the same thickness, or may be formed to have different thicknesses. Furthermore, the main mount portion 18 may be formed in a shape other than a circular shape in plan view, and may be formed in, for example, a rectangular shape and a polygonal shape. From the viewpoint of securing flexural rigidity of the mount portion 16, the thickness of the mount portion 16 is preferably 0.5 [mm] or more, more preferably 1.0 [mm] or more, and still more preferably 2.0 [mm] or more.

### (Connection Portion 24)

The connection portion 24 to which the exciter 26 for vibrating the glass plate structure 12 is mechanically attached is provided on a side of the mount portion 16 that is opposite to the glass plate structure 12. In the connection region V, the exciter 26 is fixed to the connection portion 24 on a side opposite to the mount portion 16. For example, the connection portion 24 may form a part of a housing of the exciter 26.

The connection portion 24 is formed in substantially the same shape as the mount portion 16 when viewed from the plate thickness direction of the glass plate structure 12, and includes second extending portions 27 overlapping the first extending portions 20 of the mount portion 16 on the first extending portions 20. The second extending portions 27 extend outward from the connection region V, and a second hole 24A is formed in the second extending portion 27 at a position corresponding to the first hole 16A. The second hole 24A penetrates through the second extending portion 27 and can be exemplified by an insertion hole through which the bolt 25 is inserted. The first extending portion 20 and the second extending portion 27 overlap each other and are mechanically fixed by a fastener such as the bolt 25.

The mount portion 16 and the connection portion 24 may be mechanically fastened by using at least one of a bolt, a screw, a pin, a key, a rivet, and a clip. A metal rivet such as a blind rivet, a resin rivet, or the like can be used as the rivet. The mount portion 16 and the connection portion 24 may also be fixed by using a combination of a bolt, a screw, or the like and an adhesive. Furthermore, a claw portion may be provided on at least one of the mount portion 16 and the connection portion 24, and the mount portion 16 and the connection portion 24 may be fixed by being locked by the claw portion.

The exciter 26 is connected to a power supply (not shown), and vibrates the glass plate structure 12 according to an input electric signal. An excitation direction in which the glass plate structure 12 is excited is a thickness direction of the exciter 26. As an example, the exciter 26 according to the present embodiment is a voice coil motor including a coil portion and a magnetic circuit, and one of the coil portion and the magnetic circuit is fixed to the connection portion 24 and the other is disposed so as to be relatively movable with respect to the connection portion 24. When a current flows through the coil portion, the vibration occurs due to interaction between the coil portion and the magnetic circuit, and the glass plate structure 12 is vibrated via the connection portion 24 and the mount portion 16. A vibration direction is the thickness direction of the exciter 26. The exciter 26 is not limited to the voice coil motor, and an actuator other than the voice coil motor, such as a piezoelectric type, can be adopted as long as the actuator can transmit desired vibration to the glass plate structure 12.

### (Elastic Deformation Layer 22)

The elastic deformation layer 22 is provided on a principal surface of the mount portion 16 on a side opposite to the glass plate structure 12, and the elastic deformation layer 22 is sandwiched between the mount portion 16 and the connection portion 24.

The elastic deformation layer 22 is continuously disposed in a range including the connection region V overlapping the exciter 26 when viewed from the thickness direction of the glass plate structure 12. In the present embodiment, the elastic deformation layer 22 includes a portion sandwiched between the first extending portion 20 of the mount portion 16 and the second extending portion 27 of the connection portion 24.

The elastic deformation layer 22 includes at least one of a resin, rubber, a foam material, and a gel material. The elastic deformation layer 22 may be formed of a hydrocarbon-based, silicone-based, or fluorine-based rubber material as a resin, and examples of the rubber material include rubber materials such as ethylene propylene terpolymer (EPT), ethylene propylene diene monomer (EPDM), urethane, polydimethylsiloxane (PDMS), acryl, and fluorinated ethylene propylene (FEP).

A material having no adhesiveness or a material having adhesiveness may be used as the elastic deformation layer 22. In a case where a material having adhesiveness is used as the elastic deformation layer 22, the elastic deformation layer 22 has a shear strength of preferably 5.0 [MPa] or less, more preferably 3.0 [MPa] or less, still more preferably 1.0 [MPa] or less, and particularly preferably 0.5 [MPa] or less in order to remove the connection portion 24 from the mount portion 16 at the time of replacing the exciter 26.

In addition, a thickness of the elastic deformation layer 22 is preferably 0.02 [mm] or more, more preferably 0.05 [mm] or more, and still more preferably 0.1 [mm] or more in order to allow dimensional errors and distortions of the mount portion 16. In addition, the thickness of the elastic deformation layer 22 is preferably 5.0 [mm] or less, more preferably 3.0 [mm] or less, and still more preferably 1.0 [mm] or less in order to effectively transmit the vibration of the exciter 26 to the mount portion 16.

A Young's modulus E_{M} of the elastic deformation layer 22 is preferably 1×10³ [Pa] or more, more preferably 5×10³ [Pa] or more, and still more preferably 1×10⁴ [Pa] or more. The Young's modulus Ep of the elastic deformation layer 22 is preferably 1×10⁸ [Pa] or less, more preferably 5×10⁷ [Pa] or less, and still more preferably 1×10⁷ [Pa] or less.

As described above, in the present embodiment, the elastic deformation layer 22 is sandwiched between the mount portion 16 and the connection portion 24, so that the dimensional errors, distortions, and the like of the mount portion 16 can be reduced by deformation of the elastic deformation layer 22, and an individual difference can be reduced. As a result, even in a case where variations in the shape of the mount portion 16, variations in the shape of the connection portion 24, and variations in a fixed state of the exciter 26 occur, variations in a damping ratio when the glass plate structure 12 is vibrated can be reduced, and a desired acoustic characteristic can be easily obtained. In addition, as the elastic deformation layer 22 is provided to implement a mount mechanism having a high loss coefficient, the damping ratio can be improved.

### First Modified Example

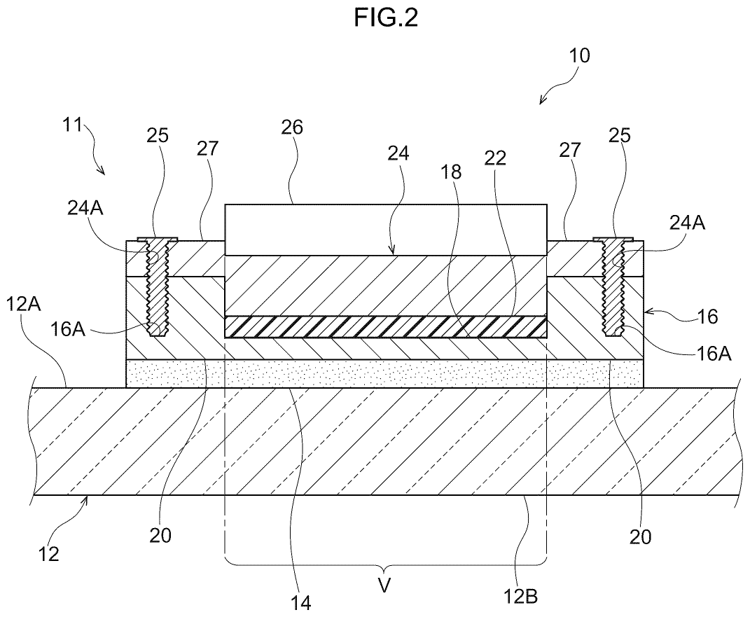

FIG. 2 is a cross-sectional view of an exciter-attached glass diaphragm 10 according to a first modified example when viewed from a side. As shown in FIG. 2, in the present modified example, shapes of a mount portion 16 and a connection portion 24 are different from those in FIG. 1.

The mount portion 16 includes a main mount portion 18 disposed in a connection region V, and first extending portions 20 extending outward from the main mount portion 18 (connection region V). The first extending portions 20 extend from outer peripheral end portions of the main mount portion 18 in directions different from each other, particularly, in directions opposite to each other. Here, the first extending portion 20 is formed to be thicker than the main mount portion 18.

A portion of the connection portion 24 that is disposed in the connection region Vis formed to be thicker than a second extending portion 27 and is disposed in a state of entering between the pair of first extending portions 20.

An elastic deformation layer 22 is provided on a principal surface of the mount portion 16 on a side opposite to a glass plate structure 12, and the elastic deformation layer 22 is sandwiched between the mount portion 16 and the connection portion 24. The elastic deformation layer 22 is disposed in a state of being interposed between the pair of first extending portions 20. In particular, in the present modified example, the elastic deformation layer 22 may be disposed including the main mount portion 18 (connection region V), and the elastic deformation layer 22 may be disposed only on the main mount portion 18 (connection region V).

In the present modified example, the first extending portion 20 is formed to be thick, a fastening strength in a case where the first extending portion 20 and the second extending portion 27 are mechanically fastened can be improved.

### Second Modified Example

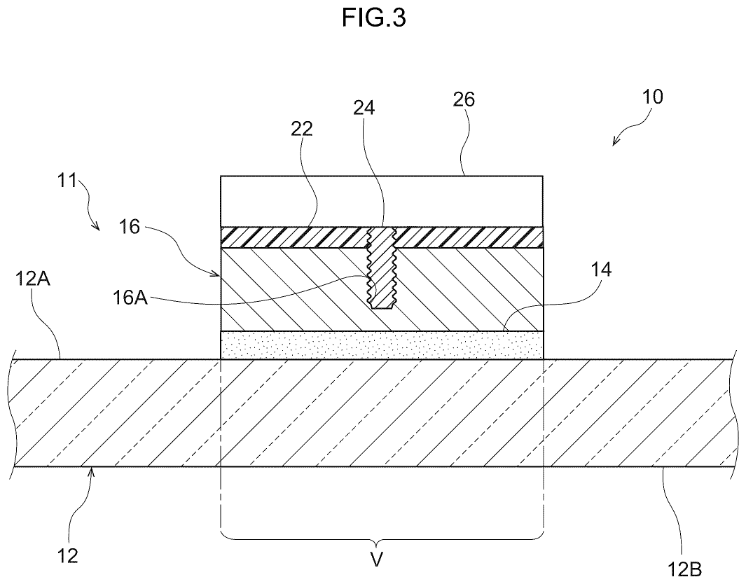

FIG. 3 is a cross-sectional view of an exciter-attached glass diaphragm 10 according to a second modified example when viewed from a side. As shown in FIG. 3, in the present modified example, a first extending portion 20 is not provided in a mount portion 16, and a second extending portion 27 is not provided in a connection portion 24.

The mount portion 16 is formed in a substantially circular shape in plan view, and a first hole 16A is formed at a central portion of the mount portion 16. In a case where a part of the mount portion 16 is formed of a resin such as a plastic, at least the periphery of a screw hole that is the first hole 16A in the mount portion 16 may be formed of hard metal such as stainless steel by helical insertion or the like, and the other portion may be formed of soft metal such as aluminum or a resin such as a plastic.

The connection portion 24 includes a mechanical fastening portion connected to the mount portion 16 inside a connection region V. The mechanical fastening portion is exemplified by a male screw portion provided at a position corresponding to a central axis of the mount portion 16.

An elastic deformation layer 22 is provided on a principal surface of the mount portion 16 on a side opposite to a glass plate structure 12, and the elastic deformation layer 22 is sandwiched between the mount portion 16 and an exciter 26. In this case, the elastic deformation layer 22 is disposed in a region excluding the male screw portion, and has a hole in a portion corresponding to the male screw portion when viewed from a thickness direction of the glass plate structure 12. Furthermore, in the present modified example, the elastic deformation layer 22 is preferably formed of a material having adhesiveness.

That is, in the present modified example, the elastic deformation layer 22 can be used as an adhesive for fixing the elastic deformation layer 22 to the mount portion 16. In addition, since the exciter 26 can be fixed to the mount portion 16 by the connection portion 24 and the elastic deformation layer 22, the exciter 26 can be firmly fixed. As the elastic deformation layer 22, a material having no adhesiveness may be used as long as the mount portion 16 and the connection portion 24 can be firmly fixed.

### Third Modified Example

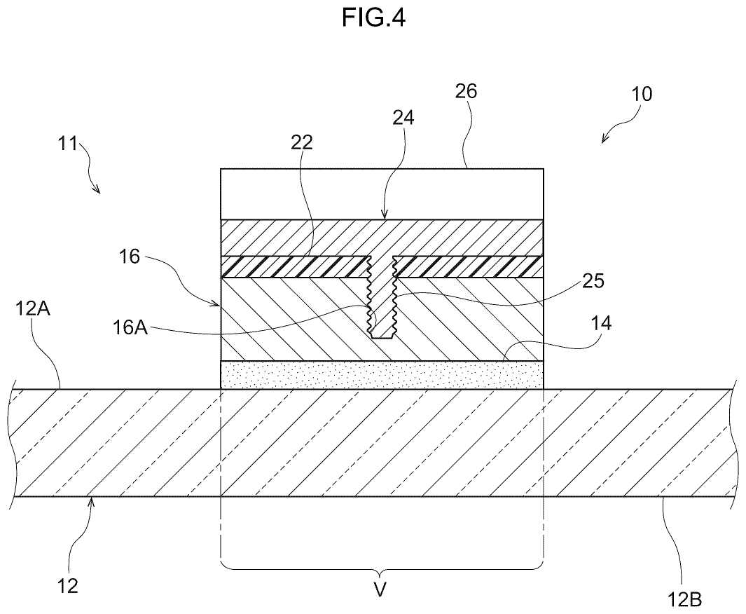

FIG. 4 is a cross-sectional view of an exciter-attached glass diaphragm 10 according to a third modified example when viewed from a side. As shown in FIG. 4, in the present modified example, a shape of a connection portion 24 is different from that of the second modified example. That is, an outer edge of the connection portion 24 has a shape that substantially coincides with that of an outer edge of a mount portion 16 when viewed from a thickness direction of a glass plate structure 12.

The connection portion 24 is disposed on a principal surface of the mount portion 16 via an elastic deformation layer 22. A male screw portion 25 extends from the center of the connection portion 24 toward the mount portion 16, and the male screw portion 25 is screwed into a first hole 16A of the mount portion 16, whereby the connection portion 24 is mechanically fastened to the mount portion 16.

### Fourth Modified Example

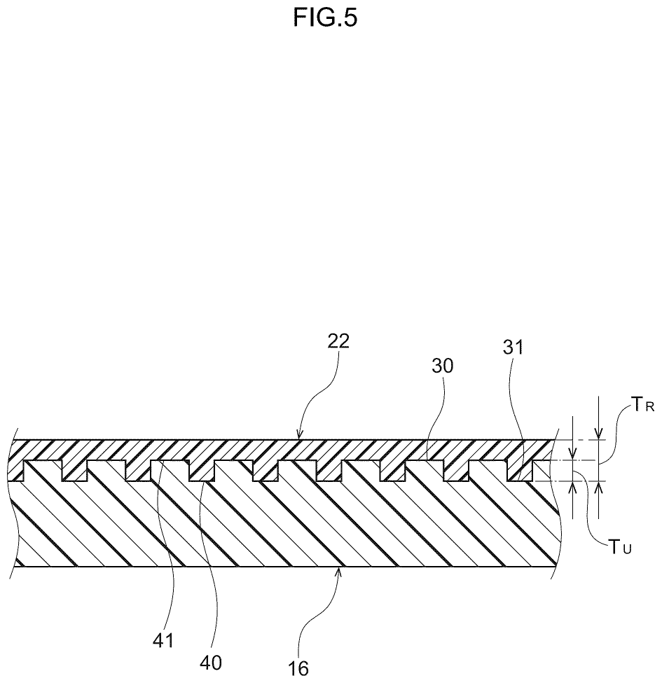

FIG. 5 is an enlarged cross-sectional view showing a mount portion 16 and an elastic deformation layer 22 according to a fourth modified example. As shown in FIG. 5, in the present modified example, a first uneven surface is formed on the mount portion 16. The first uneven surface is formed on a principal surface of the mount portion 16 on a side opposite to a glass plate structure 12, and is a surface formed in an uneven shape with respect to a virtual plane orthogonal to a central axis of the mount portion 16 extending in a thickness direction of the glass plate structure 12.

The first uneven surface includes projections 30 protruding from the mount portion 16 toward the elastic deformation layer 22 and depressions 31 formed between the projections 30. The first uneven surface may be formed in the entire connection region or only a part of the connection region.

A height of irregularities on the first uneven surface is 0.1 [μm] to 5.0 [mm], but is not limited to this range. In FIG. 5, a maximum height T_{U} from a top portion of the projection 30 to a bottom portion of the depression 31 is set to 0.1 [μm] to 5.0 [mm]. A range of the maximum height T_{U} may be 1.0 [μm] to 3.0 [mm], 10 [μm] to 1.0 [mm], or 20 [μm] to 0.5 [mm].

A surface of the elastic deformation layer 22 on a side adjacent to the mount portion 16 is formed in an uneven shape following the first uneven surface. Specifically, the elastic deformation layer 22 includes protrusions 40 and recesses 41, and the protrusion 40 enters the depression 31 of the mount portion 16. The projection 30 of the mount portion 16 is inserted between the recesses 41. A range of an aspect ratio (a ratio between a maximum width and a maximum height (depth)) of the protrusion and the recess is 1:100 to 100:1, preferably 1:50 to 50:1, more preferably 1:20 to 20:1, and still more preferably 1:10 to 10:1.

Here, a maximum thickness T_{R} of the elastic deformation layer 22 is larger than the maximum height T_{U} of the first uneven surface.

In the present modified example, the mount portion 16 that is in contact with the elastic deformation layer 22 has the first uneven surface, and thus, the elastic deformation layer 22 follows the first uneven surface so as to be engaged with the first uneven surface, so that the elastic deformation layer 22 can be firmly fixed to the mount portion 16, and misalignment can be easily reduced.

### Fifth Modified Example

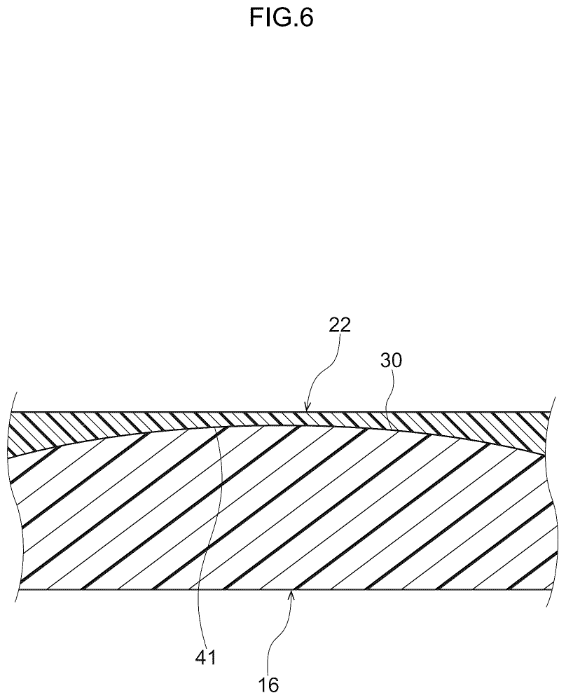

FIG. 6 is an enlarged cross-sectional view showing a mount portion 16 and an elastic deformation layer 22 according to a fifth modified example. As shown in FIG. 6, in the present modified example, a first uneven surface is formed on the mount portion 16.

The first uneven surface includes one projection 30 bulging from the mount portion 16 toward the elastic deformation layer 22. A recess 41 following the projection 30 is formed on a surface of the elastic deformation layer 22 on a side adjacent to the mount portion 16.

### Sixth Modified Example

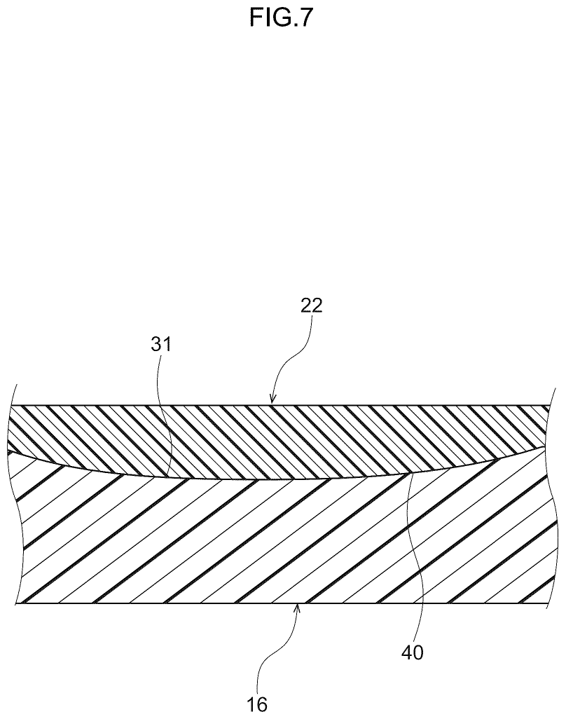

FIG. 7 is an enlarged cross-sectional view showing a mount portion 16 and an elastic deformation layer 22 according to a sixth modified example. As shown in FIG. 7, in the present modified example, a first uneven surface is formed on the mount portion 16.

The first uneven surface includes one depression 31 formed in the mount portion 16. A protrusion 40 following the depression 31 is formed on a surface of the elastic deformation layer 22 on a side adjacent to the mount portion 16.

### Seventh Modified Example

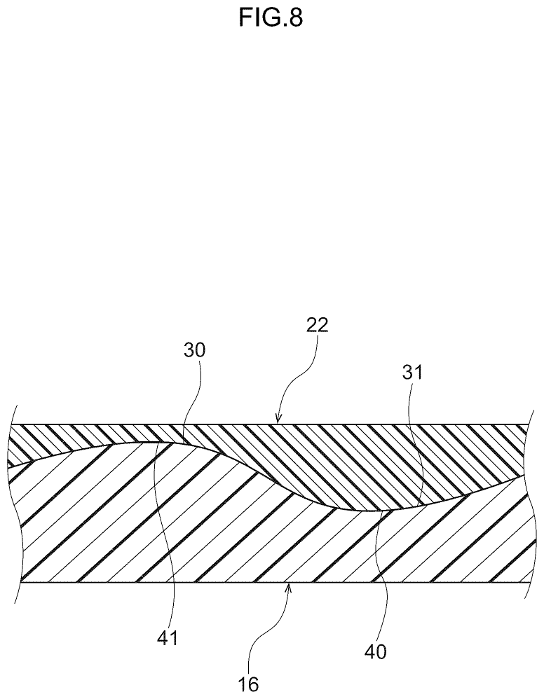

FIG. 8 is an enlarged cross-sectional view showing a mount portion 16 and an elastic deformation layer 22 according to a seventh modified example. As shown in FIG. 8, in the present modified example, a first uneven surface is formed on the mount portion 16.

The first uneven surface includes two or more projections 30 bulging from the mount portion 16 toward the elastic deformation layer 22. The projections 30 are continuously formed in a wave shape. A recess 41 following the projection 30 is formed on a surface of the elastic deformation layer 22 on a side adjacent to the mount portion 16.

In the fifth to seventh modified examples, a (periodic) pitch of irregularities is wider than that of the first uneven surface of the fourth modified example, and the first uneven surface of the mount portion 16 has a significant undulation (distortion). For example, in the fifth to seventh modified examples, even in a case where the mount portion 16 is processed into a flat shape, the first uneven surface can be distorted depending on a manufacturing condition, and the presence or absence of distortion and the magnitude of distortion (a height of the irregularities) cannot be visually determined. Therefore, in the fifth to seventh modified examples, since the elastic deformation layer 22 is provided, the elastic deformation layer 22 can be deformed so as to reduce the height (distortion) of the first uneven surface, and high-precision specifications need not be required for a shape of a principal surface of the mount portion 16 that is in contact with the elastic deformation layer 22. As described above, as the elastic deformation layer 22 is provided, productivity for the mount portion 16 can be enhanced.

### Eighth Modified Example

FIG. 9 is a perspective view of a mount portion according to an eighth modified example. As shown in FIG. 9, in the present modified example, a first uneven surface is formed on a main mount portion 18 of a mount portion 16. The first uneven surface includes at least one of a protruding portion 32 and a recessed portion 33 linearly formed with a predetermined width. The widths of the linear protruding portion 32 and the linear recessed portion 33 may be uniform, and at least a part of the widths may gradually increase or gradually decrease. For example, one of the protruding portion 32 and the recessed portion 33 may have a wedge shape in plan view.

The first uneven surface may be formed only by the protruding portion 32, or the first uneven surface may be formed only by the recessed portion 33. Further, the linear protruding portion 32 and the linear recessed portion 33 may be formed substantially in parallel, or may be formed at an angle with respect to each other. Furthermore, the linear protruding portion 32 and the linear recessed portion 33 may be formed to intersect each other.

The first uneven surface may be formed by two or more protruding portions 32 and recessed portions 33, or the first uneven surface may be formed by only one protruding portion 32 or recessed portion 33.

### Ninth Modified Example

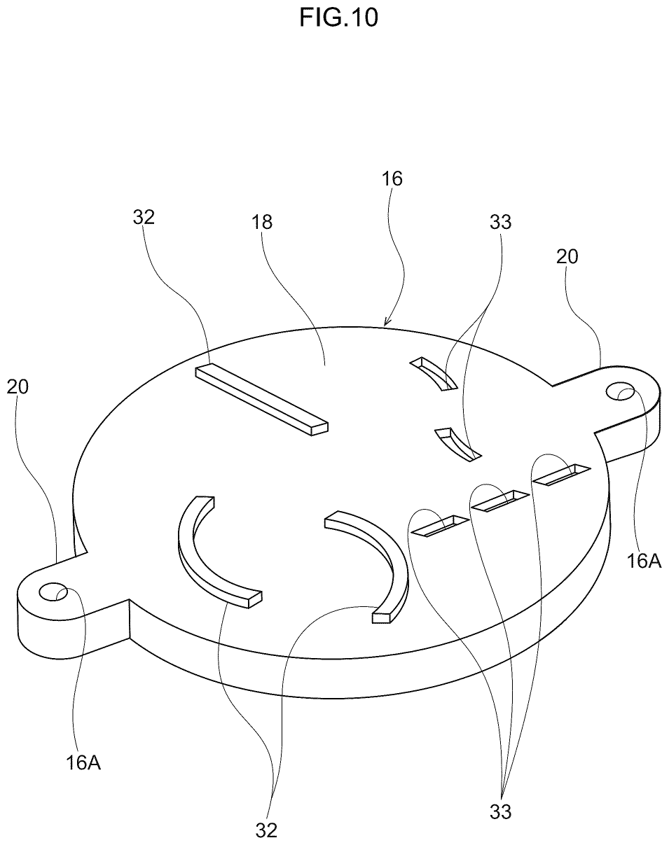

FIG. 10 is a perspective view of a mount portion according to a ninth modified example. As shown in FIG. 10, in the present modified example, a first uneven surface is formed on a main mount portion 18 of a mount portion 16. The first uneven surface is formed to include at least one of a linear protruding portion 32 and a linear recessed portion 33. A line width may be uniform as described in the eighth modified example, and a part of the line width may gradually increase or gradually decrease.

In the present modified example, three protruding portions 32 are formed on the main mount portion 18, and two of the protruding portions 32 are formed in a curved shape. However, all of the three protruding portions 32 may be formed in a curved shape, or all of the three protruding portions 32 may be formed in a linear shape. In addition, some of the protruding portions 32 may be intermittently formed.

Further, in the present modified example, five recessed portions 33 are formed in the main mount portion 18, and three of the recessed portions 33 are intermittently formed in a linear shape. However, four or more of the recessed portions 33 may be formed intermittently, or two of the recessed portions 33 may be formed intermittently.

In FIG. 10, two recessed portions 33 are intermittently formed in a curved shape among the five recessed portions 33, but three or more recessed portions 33 may be intermittently formed in a curved shape. Further, lengths of the recessed portions 33 may be different from each other, or may be the same as each other.

Further, in FIG. 10, the first uneven surface is formed by the protruding portions 32 and the recessed portions 33 which are irregularly provided, but the first uneven surface may be formed by the protruding portions 32 and the recessed portions 33 which are regularly provided.

### Tenth Modified Example

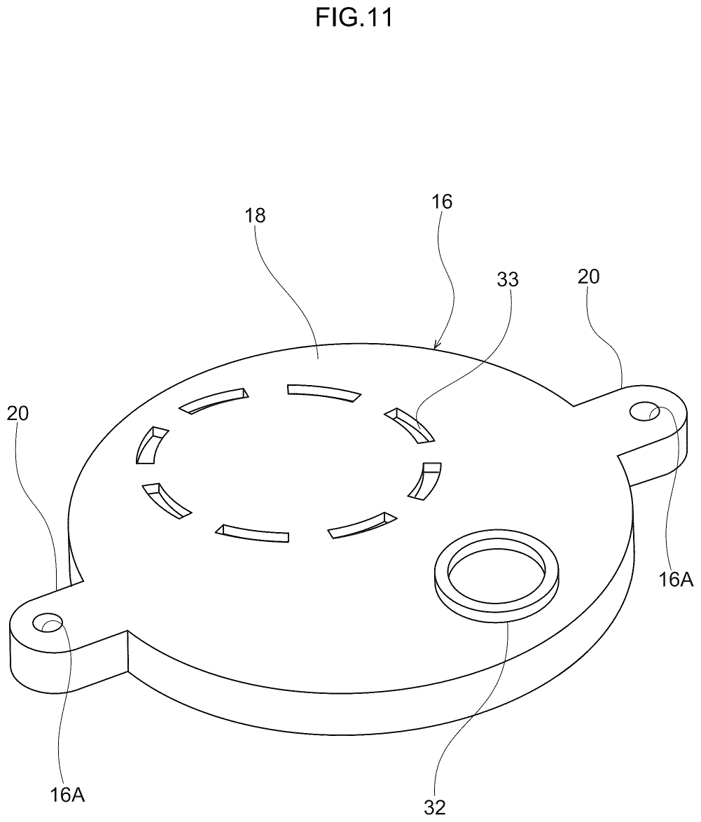

FIG. 11 is a perspective view of a mount portion according to a tenth modified example. As shown in FIG. 11, in the present modified example, a first uneven surface is formed on a main mount portion 18 of a mount portion 16. The first uneven surface includes at least one of a protruding portion 32 and a recessed portion 33 formed in a circular line shape.

The protruding portion 32 is formed in a continuous circular line shape, and may be formed in an intermittent circular line shape. The recessed portion 33 is formed in an intermittent circular line shape, and may be formed in a continuous circular line shape. Also in the present modified example, line widths of the protruding portion 32 and the recessed portion 33 may be uniform as in the eighth modified example, and a part of the line widths may gradually increase or gradually decrease.

### Eleventh Modified Example

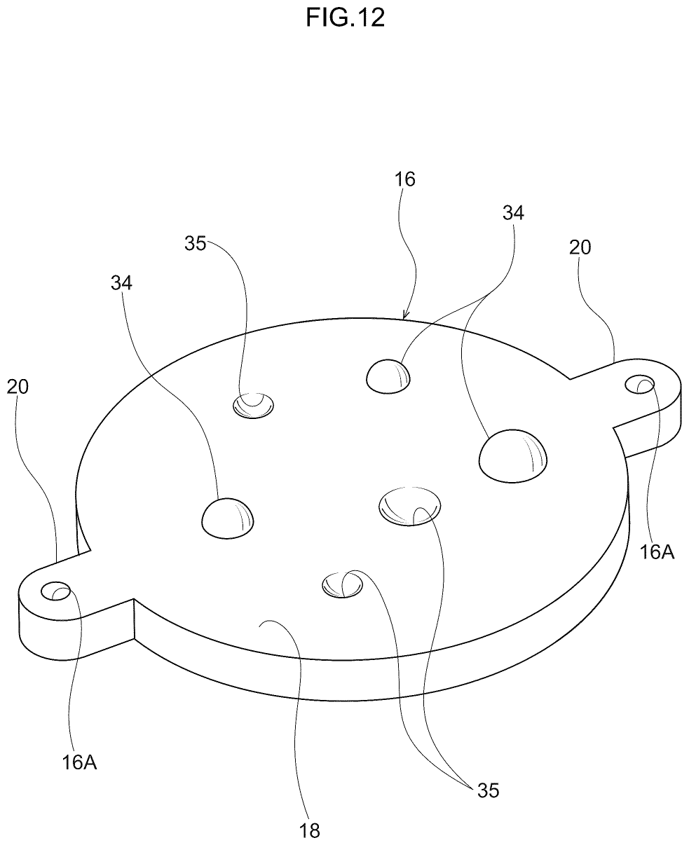

FIG. 12 is a perspective view of a mount portion according to an eleventh modified example. As shown in FIG. 12, in the present modified example, a first uneven surface is formed on a main mount portion 18 of a mount portion 16. The first uneven surface is formed to include at least one of projections 34 and depressions 35 that are irregularly scattered.

Although three projections 34 and three depressions 35 are formed in the main mount portion 18, the number of projections 34 and depressions 35 is not limited, and only a plurality of projections 34 may be formed, or only a plurality of depressions 35 may be formed. In addition, the projections 34 and the depressions 35 may be regularly formed. Further, the projections 34 may include a plurality of apexes formed by connecting lower portions (portions corresponding to skirt portions) of the plurality of projections 34. Further, the depression 35 may include a plurality of bottom portions (portions having minimum values) formed by connecting upper portions of the plurality of depressions 35 (shallow portions of the depressions 35).

In addition, the first uneven surface may be formed by combining the protruding portion 32, the recessed portion 33, the projection 34, and the depression 35 tightened in FIGS. 9 to 12. For example, in FIG. 12, the main mount portion 18 may include a linear protruding portion 32 and a linear recessed portion 33.

### Twelfth Modified Example

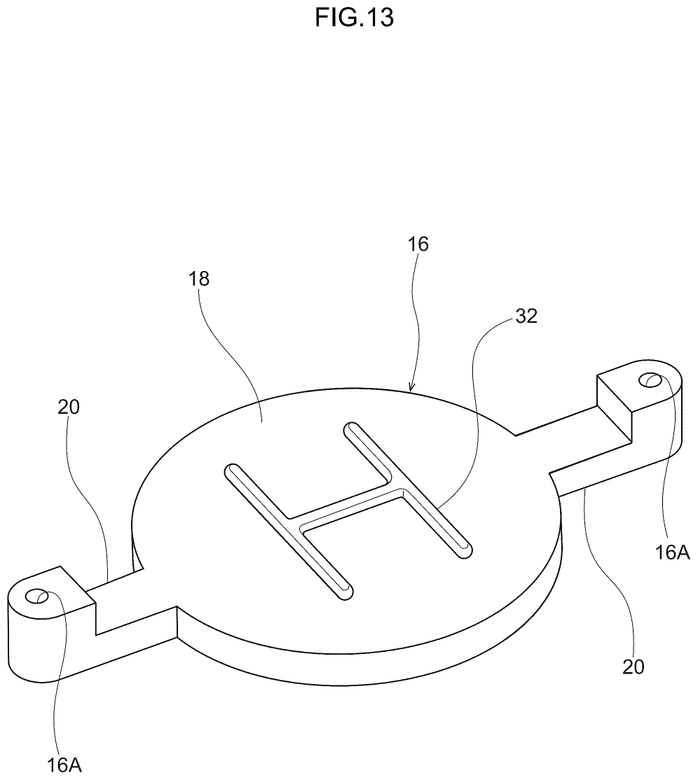

FIG. 13 is a perspective view of a mount portion according to a twelfth modified example. As shown in FIG. 13, in the present modified example, a first uneven surface is formed on a main mount portion 18 of a mount portion 16. The first uneven surface is formed by a substantially H-shaped protruding portion 32.

The protruding portion 32 may be formed by connecting a plurality of linear protruding portions intersecting each other. The first uneven surface may be formed by a substantially H-shaped recessed portion 33 instead of the protruding portion 32. Further, a part of the H shape may be formed by the recessed portion 33. Forming the substantially H-shaped protruding portion 32 or recessed portion 33 on the first uneven surface improves a bending strength of the main mount portion 18.

### (Thirteenth Modified Example)

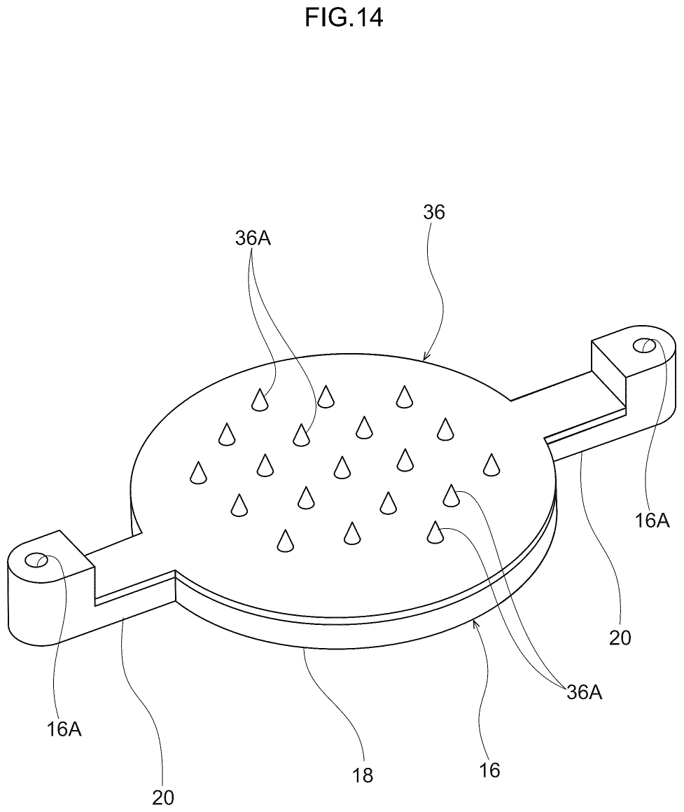

FIG. 14 is a perspective view of a mount portion according to a thirteenth modified example. As shown in FIG. 14, in the present modified example, a coating film 36 is layered on a part of a main mount portion 18 and a first extending portion 20 of a mount portion 16.

The coating film 36 contains a large number of particles 36A, and a first uneven surface is formed on the main mount portion 18 by the large number of particles 36A. In FIG. 14, a size of the particle 36A is exaggerated for convenience of description. Furthermore, in FIG. 14, for convenience of description, an interval between the particles 36A is drawn substantially uniform, but the particles 36A may be formed at irregular intervals.

The first uneven surface formed by the particles 36A has an arithmetic surface roughness Ra in accordance with JIS B 0601:2001 of 1.0 [μm] to 3000 [μm], preferably 2.0 [μm] to 1000 [μm], more preferably 5.0 [μm] to 500 [μm], and more preferably 10.0 [μm] to 200 [μm].

### Fourteenth Modified Example

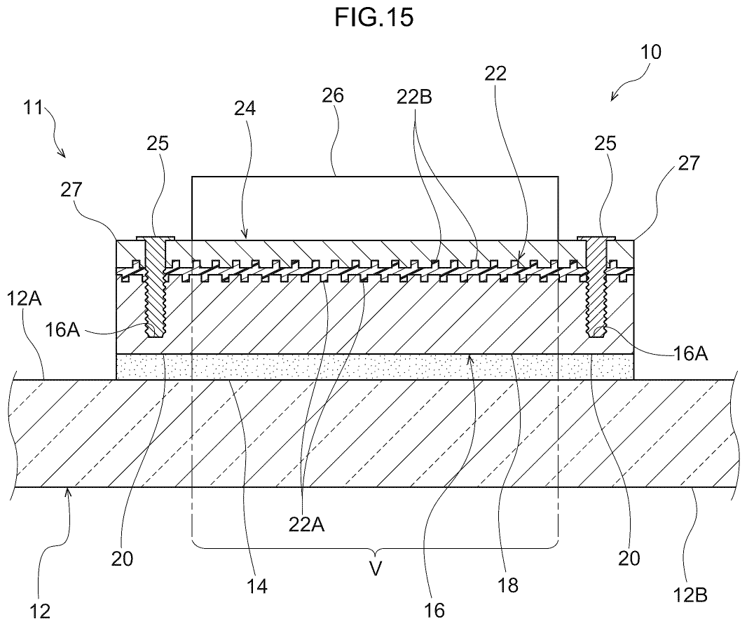

FIG. 15 is a cross-sectional view of an exciter-attached glass diaphragm 10 according to a fourteenth modified example when viewed from a side. As shown in FIG. 15, in the present modified example, shapes of a mount portion 16 and a connection portion 24 are different from those of the embodiment.

The mount portion 16 includes a main mount portion 18 disposed in a connection region V, and first extending portions 20 extending outward from the main mount portion 18 (connection region V). The first extending portions 20 extend from outer peripheral end portions of the main mount portion 18 in directions opposite to each other. The connection portion 24 is formed in substantially the same shape as the mount portion 16 when viewed from a thickness direction of a glass plate structure 12, and includes second extending portions 27 overlapping the first extending portions 20 of the mount portion 16 on the first extending portions 20. The second extending portion 27 extends outward from the connection region V, and the first extending portion 20 and the second extending portion 27 overlap each other and are mechanically fixed by a fastener such as a bolt 25.

Here, a first uneven surface is formed on the mount portion 16. The first uneven surface is formed on a principal surface of the mount portion 16 on a side opposite to the glass plate structure 12, and is a surface formed in an uneven shape with respect to a virtual plane orthogonal to a central axis of the mount portion 16 extending in the thickness direction of the glass plate structure 12. A second uneven surface is formed on the connection portion 24. The second uneven surface is formed on a principal surface of the connection portion 24 on a side adjacent to the mount portion 16, and is formed in an uneven shape with respect to a virtual plane orthogonal to a central axis of the connection portion 24 extending in the thickness direction of the glass plate structure 12.

An elastic deformation layer 22 is provided between the mount portion 16 and the connection portion 24. A projection 22A following the first uneven surface is formed on a surface of the elastic deformation layer 22 on a side adjacent to the mount portion 16. Further, a projection 22B following the second uneven surface is formed on a surface of the elastic deformation layer 22 on a side adjacent to the connection portion 24.

In the present modified example, the elastic deformation layer 22 follows so as to be engaged with both the first uneven surface and the second uneven surface in contact with the elastic deformation layer 22, and thus can be more firmly fixed to both the mount portion 16 and the connection portion 24. The first uneven surface and the second uneven surface in the present modified example have been described with an example in which a large number of fine irregularities are provided as in the fourth modified example shown in FIG. 5, but the present disclosure is not limited thereto. That is, a combination of the first uneven surface and the second uneven surface may be any combination of the fourth to thirteenth modified examples.

### Fifteenth Modified Example

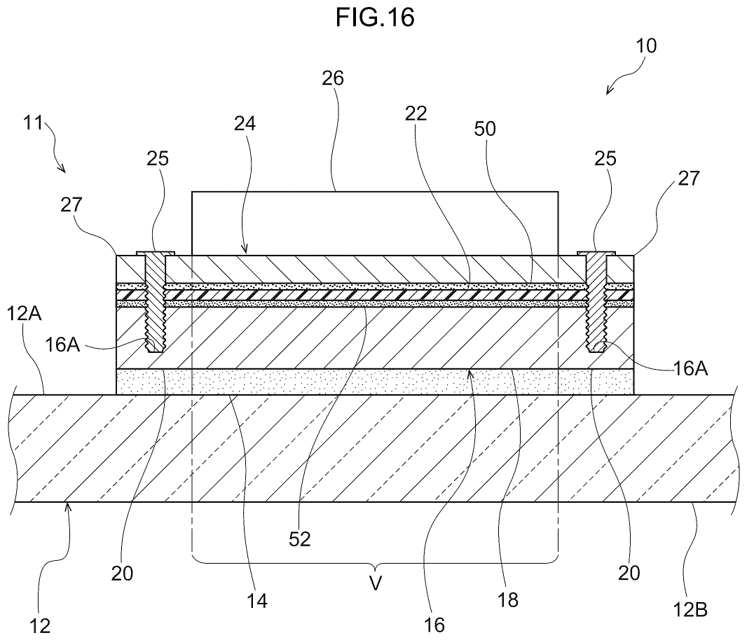

FIG. 16 is a cross-sectional view of an exciter-attached glass diaphragm 10 according to a fifteenth modified example when viewed from a side. As shown in FIG. 16, in the present modified example, a first adhesive layer 50 is disposed between a connection portion 24 and an elastic deformation layer 22. In addition, a second adhesive layer 52 is disposed between a mount portion 16 and the elastic deformation layer 22. Any one of the first adhesive layer 50 and the second adhesive layer 52 may be disposed.

The first adhesive layer 50 is disposed over the entire region including second extending portions 27 in the connection portion 24, and an adhesive, a pressure-sensitive adhesive, or the like can be appropriately used similarly to the adhesive layer 14. A pressure-sensitive adhesive tape formed in a sheet shape can be used as the pressure-sensitive adhesive. A sheet-shaped thermosetting resin material or the like may be used as the first adhesive layer 50.

The second adhesive layer 52 is disposed over the entire region including a main mount portion 18 and first extending portions 20, and the same material as that of the first adhesive layer 50 can be used. In addition, the first adhesive layer 50 and the second adhesive layer 52 may be formed of different materials.

In the present modified example, even in a case where the elastic deformation layer 22 is formed of a material having no adhesiveness, the elastic deformation layer 22 can be fixed to the mount portion 16 and the connection portion 24. Also in the present modified example, the elastic deformation layer 22 may be formed of a material having adhesiveness.

### Sixteenth Modified Example

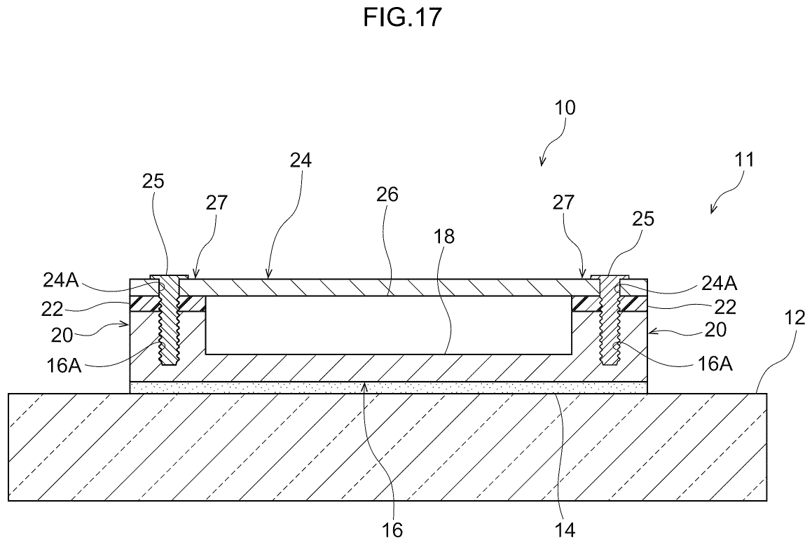

FIG. 17 is a cross-sectional view of an exciter-attached glass diaphragm 10 according to a sixteenth modified example when viewed from a side. As shown in FIG. 17, a mount portion 16 is fixed to a principal surface of a glass plate structure 12 on one side via an adhesive layer 14. The mount portion 16 includes a main mount portion 18 and first extending portions 20.

The main mount portion 18 includes a portion formed in a substantially circular shape in plan view of the glass plate structure 12 and arm portions extending radially outward from an outer edge of the substantially circular shape and separated from each other. The first extending portion 20 is formed at a distal end of the arm portion, and the first extending portion 20 is formed to be thicker than the main mount portion 18. Each of three first extending portions 20 has a hole 16A.

A connection portion 24 is provided on a side of the mount portion 16 that is opposite to the glass plate structure 12. The connection portion 24 is formed in substantially the same shape as the mount portion 16 when viewed from a plate thickness direction of the glass plate structure 12, and includes second extending portions 27 overlapping the first extending portions 20 of the mount portion 16 on the first extending portions 20.

The connection portion 24 according to the present modified example is formed to have the same thickness as a whole, and a second hole 24A is formed in the second extending portion 27 at a position corresponding to the first hole 16A. The second hole 24A penetrates through the second extending portion 27 and can be exemplified by an insertion hole through which a bolt 25 is inserted. The first extending portion 20 and the second extending portion 27 overlap each other and are mechanically fixed by a fastener such as the bolt 25.

The elastic deformation layer 22 is provided on a principal surface of the mount portion 16 on a side opposite to the glass plate structure 12. The elastic deformation layer 22 is sandwiched between the mount portion 16 and the connection portion 24. In particular, in the present modified example, the elastic deformation layer 22 is provided between the first extending portion 20 and the second extending portion 27.

In the present modified example, an exciter 26 is disposed in a space surrounded by the connection portion 24 and the mount portion 16. In addition, since the exciter 26 is covered with the connection portion 24, the exciter 26 is not exposed to the outside. In the present modified example, since the exciter 26 is not exposed to the outside, the exciter 26 is not directly touched.

### Seventeenth Modified Example

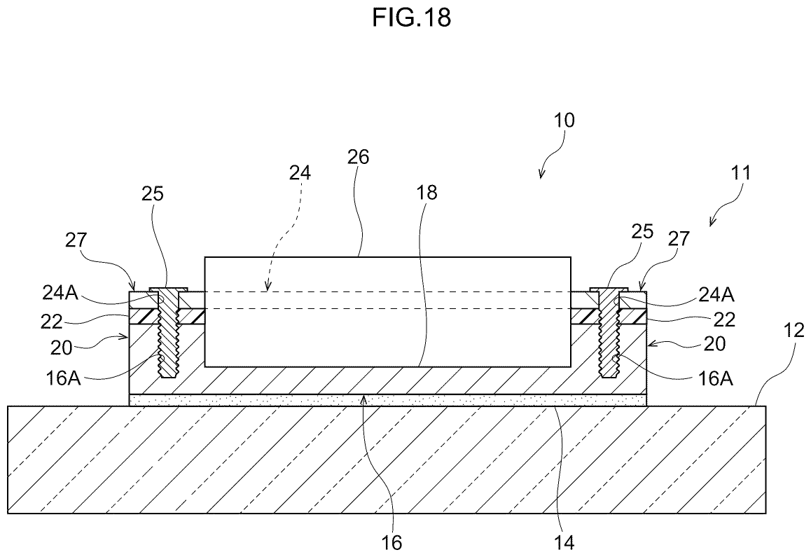

FIG. 18 is a cross-sectional view of an exciter-attached glass diaphragm 10 according to a seventeenth modified example when viewed from a side. As shown in FIG. 18, a mount portion 16 includes a main mount portion 18 and first extending portions 20 that are thicker than the main mount portion 18.

A connection portion 24 is provided on a side of the mount portion 16 that is opposite to a glass plate structure 12. The connection portion 24 includes second extending portions 27 that do not overlap an exciter 26 in plan view of the glass plate structure 12, and a through hole 24A penetrating in a plate thickness direction is formed in the second extending portion 27.

Here, in the present modified example, a part of the exciter 26 is disposed in a space surrounded by the connection portion 24 and the mount portion 16, and the other part of the exciter 26 is disposed outside the connection portion 24. As described above, in the present modified example, the exciter 26 can be attached even in a case where the exciter 26 is thick.

### Experimental Example

Hereinafter, the embodiment of the present disclosure will be described more specifically with reference to examples. Materials, dimensions, shapes, and evaluation procedures described in the following examples can be appropriately changed without departing from the gist of the embodiment of the present disclosure. Therefore, the scope of the embodiment of the present disclosure is not limited to the following specific examples.

### (Exciter-Attached Glass Diaphragm)

As examples, a structure of the embodiment shown in FIG. 1 was adopted as the exciter-attached glass diaphragm 10. The thickness of the elastic deformation layer 22 was 1 [mm]. In addition, as comparative examples, a structure in which the elastic deformation layer 22 is removed from the structure of the embodiment shown in FIG. 1 was adopted.

For the structures of the examples and the comparative examples, the exciter 26 was vibrated to measure the damping ratio. For the measurement of the damping ratio, an acceleration sensor (NP-3200, manufactured by ONO SOKKI CO., LTD.) and an FFT analyzer (DS-3200, manufactured by ONO SOKKI CO., LTD.) were used. Results of performing the measurement three times for the respective structures are as shown in Table 1 below. Damping ratios ζ in the examples and the comparative examples were calculated by a half-width method, and specifically, in a case where a peak frequency when a horizontal axis represents frequency is f₀, a frequency width Δf at (two) points lower than a peak value by 3 dB was obtained, and the damping ratio (was obtained by a relational expression “ζ=Δf/(2f₀)”.

TABLE 1

| | First | Second | Third | Average |
|---|---|---|---|---|
| | Measurement | Measurement | Measurement | Value |
| Example | 6.15 | 6.49 | 6.55 | 6.40 |
| Comparative | 5.27 | 5.49 | 4.93 | 5.23 |
| Example | | | | |

It can be seen from the results described in Table 1 that the structures of the examples in which the elastic deformation layer 22 is sandwiched between the mount portion 16 and the connection portion 24 have larger damping ratios than those of the structures of the comparative examples. As a result, by providing the elastic deformation layer 22, sound damping is improved, and various characteristics such as transient response (tone burst) can be improved.

As described above, as the elastic deformation layer is provided, it is possible to implement a mount configuration having a higher damping ratio than a case according to the related art in addition to the advantage in the fastening process, and obtain desired sound as the glass diaphragm. Although the exciter-attached glass diaphragms 10 and the glass diaphragm 11 according to the embodiment and the modified examples have been described, it is needless to say that the present disclosure can be implemented in various modes without departing from the gist of the present disclosure.

What is claimed is:

1. A glass diaphragm comprising:
a glass plate structure;
a mount portion fixed to a principal surface of the glass plate structure on one side;
a connection portion provided on a side of the mount portion that is opposite to the glass plate structure and to which an exciter for vibrating the glass plate structure is mechanically attached; and
an elastic deformation layer provided on a principal surface of the mount portion on a side opposite to the glass plate structure.

2. The glass diaphragm according to claim 1, wherein the elastic deformation layer contains a resin.

3. The glass diaphragm according to claim 1, wherein the elastic deformation layer is continuously disposed in a range including a connection region overlapping the exciter when viewed from a thickness direction of the glass plate structure.

4. The glass diaphragm according to claim 1, wherein the principal surface of the mount portion on the side opposite to the glass plate structure includes a first uneven surface formed in an uneven shape with respect to a virtual plane orthogonal to a central axis of the mount portion extending in a thickness direction of the glass plate structure.

5. The glass diaphragm according to claim 4, wherein a maximum thickness T_{R} of the elastic deformation layer is larger than a maximum height T_{U} of the first uneven surface.

6. The glass diaphragm according to claim 4, wherein the first uneven surface includes at least one of a linear protruding portion and a linear recessed portion.

7. The glass diaphragm according to claim 6, wherein the protruding portion and the recessed portion are formed to intersect each other.

8. The glass diaphragm according to claim 4, wherein the first uneven surface is irregularly formed.

9. The glass diaphragm according to claim 8, wherein the first uneven surface includes at least one of projections and depressions that are irregularly scattered.

10. The glass diaphragm according to claim 9, wherein the first uneven surface has an arithmetic surface roughness Ra in accordance with JIS B 0601:2001 of 1.0 [μm] to 3000 [μm].

11. The glass diaphragm according to claim 10, wherein the first uneven surface is formed over the entire connection region.

12. The glass diaphragm according to claim 10, wherein a height of irregularities on the first uneven surface is 0.1 [μm] to 5.0 [mm].

13. The glass diaphragm according to claim 1, wherein a principal surface of the connection portion on a side adjacent to the mount portion includes a second uneven surface formed in an uneven shape with respect to a virtual plane orthogonal to a central axis of the connection portion extending in a thickness direction of the glass plate structure.

14. The glass diaphragm according to claim 1, further comprising at least one of a first adhesive layer disposed between the connection portion and the elastic deformation layer and a second adhesive layer disposed between the mount portion and the elastic deformation layer.

15. The glass diaphragm according to claim 1, wherein the elastic deformation layer has adhesiveness.

16. The glass diaphragm according to claim 1, wherein
the mount portion includes a first extending portion extending outward from the connection region,
the connection portion includes a second extending portion extending outward from the connection region, and
the first extending portion and the second extending portion overlap each other and are mechanically fixed to each other.

17. The glass diaphragm according to claim 16, wherein the elastic deformation layer includes a portion sandwiched between the first extending portion and the second extending portion.

18. The glass diaphragm according to claim 1, wherein the connection portion includes a mechanical fastening portion connected to the mount portion inside the connection region.

19. The glass diaphragm according to claim 1, wherein the elastic deformation layer contains at least one of rubber, a foam material, and a gel material.

20. An exciter-attached glass diaphragm comprising:
the glass diaphragm according to claim 1; and
the exciter attached to the connection portion.
